(19) United States
(12) Patent Application Publication
(10) Pub. No.: US 2012/0267146 A1
(43) Pub. Date: Oct. 25, 2012

(54) WIRE SEPARATOR SUITABLE FOR USE IN A CABLE SPLICE ENCLOSURE

(76) Inventors: Michael Petry, Neuss (DE); Bernd Schubert, Neuss (DE)

(21) Appl. No.: 13/509,932

(22) PCT Filed: Nov. 30, 2010
(86) PCT No.: PCT/US10/58325

§ 371 Date: Jul. 9, 2012

(30) Foreign Application Priority Data
Dec. 2, 2009 (GB) 0921073.3
Feb. 5, 2010 (DE) 202010002004.2

(51) Int. Cl. H02G 1/00; H01R 43/00

(52) U.S. Cl. 174/135; 29/869

(57) ABSTRACT

A separator for separating the connected wires of spliced multi-core cables in a splice enclosure comprises a core and a plurality of separating arms extending outwardly from the core to define, around the core, a plurality of locations for receiving the connected wires. Some at least of the separating arms are individually-attached to the core whereby the number of said wire-receiving locations can be varied by changing the number of separating arms attached to the core.

### TECHNICAL FIELD

The present invention relates to separators for use in cable splice enclosures, to separate the connected wires of spliced multi-core cables.

### BACKGROUND

Wire separators are known for use in various situations, when it is desirable or essential to maintain a separation between the wires of a multi-core cable. One such situation is when a splice is made between two multi-core cables, involving removal of end portions of the cable sheaths so that the individual wires of the two cables can be connected together and the subsequent sealing of the splice within an enclosure to isolate it from the surrounding environment. In some cases, the insulation of the individual wires must removed (for example when the wires are to be connected together using suitable connectors) and it is then essential to ensure a minimum distance between the connected wires in the vicinity of the splice (i.e. where the insulation has been removed), and also between the connected wires and the splice enclosure. This is especially important when the splice enclosure has a comparatively small cross-sectional area, for example 25 mm² or less.

Wire separators for use in cable splice enclosures are described, for example, in EP 1 207 608 (Tyco Electronics Corporation). Each of those separators comprises a reservoir containing sealant material, and channel members that extend from side walls of the reservoir and provide channels for receiving the wires of four-core spliced cables.

Other forms of wire separator are described in DE 35 27 658 (Cellpack AG) and U.S. Pat. No. 6,099,345 (Hubbell Incorporated). DE 35 27 658 describes various forms of expansion plug for use when the free ends of multi-core cables are being insulated: each of the described expansion plugs has a plurality of spreading fins corresponding to the number of wires in a cable, the longitudinal section of the fins being wedge-shaped so that the expansion plug can be pushed into the cable end to separate the wires. U.S. Pat. No. 6,099,345 describes various forms of wire spacer for use in electrical connectors, specifically for maintaining the separation of twisted wire pairs in a cable which is secured to an electrical connector: each of the described wire spacers has a central core and four radially-outwardly projecting flanges angularly spaced from one another by substantially 90°.

### SUMMARY

The present invention is concerned with the provision of a wire separator, suitable for use in cable splice enclosures, that is not restricted to use with multi-core cables comprising a specific number (e.g. four) of wires but can readily be adapted for use with cables comprising a different number of wires (e.g. those comprising five wires). The invention is further concerned with the provision of a wire separator that is simple and cost-effective to manufacture; that is easy to install in a splice enclosure under field conditions; and that will not occupy an excessive amount of space within a splice enclosure.

The present invention provides a separator for separating the connected wires of spliced multi-core cables in a splice enclosure, the separator comprising a core and a plurality of separating arms extending outwardly from the core to define, around the core, a plurality of locations for receiving the connected wires; wherein some at least of the separating arms are individually-attached to the core whereby the number of said wire-receiving locations can be varied by changing the number of separating arms attached to the core.

A separator in accordance with the invention can be adapted to accommodate different numbers of cable cores by changing the number of separating arms that are attached to the core. Through an appropriate selection of the size of the core and the thickness of the separating arms, a separator in accordance with the invention can maintain a required minimum distance between the connected wires of the spliced cables.

In an embodiment of the invention, the core has at least one separating arm permanently-attached thereto. This configuration can facilitate the positioning of the separator between the connected wires of spliced cables, and ensuring that the core is centrally located relative to the connected wires.

The individually-attached separating arms may be a snap-fit on the core, thereby facilitating assembly of the separator under field conditions. In one embodiment, the core comprises attachment formations on which the individually-attached separating arms are a snap-fit. In another embodiment, each individually-attached separating arm comprises a resiliently-flexible hook that is a snap-fit engagement with one end of the core. The arm may comprise a second hook that is engageable with the other end of the core: the second hook may be rigid to assist in defining the location of the separating arm on the core, or it may be identical to the first hook to eliminate the need to distinguish one end of a separating arm from the other during assembly of the separator.

Advantageously, the separating arms are movable relative to the core to adjust the size of the wire-receiving locations. In an embodiment in which the arms are a snap fit on attachment formations on the core, the arms are capable of limited rotation on the attachment formations. In another embodiment, the spacing of the arms around the core is adjustable.

A separator in accordance with the invention may further comprise stops on the separating arms to limit movement of the connected wires away from the core. Through appropriate positioning of the stops, movement of the connected wires away from the core can be restricted to ensure that a minimum distance is maintained between the connected wires and a surrounding splice enclosure.

The present invention further provides a cable splice kit comprising a separator as defined above in combination with a splice enclosure; the splice enclosure being shaped to enclose a splice between multi-core cables with the individual spliced wires of the cables located in respective ones of the wire-receiving locations of the wire separator. Because the separator is easily assembled, the kit facilitates the splicing of two multi-core cables in the field, with a required minimum spacing between the connected wires of the cables to ensure adequate electrical isolation of the wires.

The splice enclosure may be shaped to enclose an in-line splice between two multi-core cables. The splice enclosure may have an inlet through which a resin can be poured into the enclosure to surround a cable splice within the enclosure. The cable splice kit may further comprise electrical connectors for joining together the wires of multi-core cables.

The present invention further provides a kit for assembling a separator as defined above, the kit comprising a core and a plurality of separating arms individually-attachable to the core to extend outwardly from the core member and define, around the core, a required number of the said wire-receiving locations. The separator is easily assembled from the comparatively simple kit, and facilitates the splicing of two multi-core cables in the field with a required minimum spacing between the connected wires of the cables to ensure adequate electrical isolation of the wires.

The present invention further provides method of forming a splice between multi-core cables, the method including the steps of providing a kit as defined above, and attaching separating arms to the core to form wire-receiving locations corresponding in number to the number of connected wires in the splice. The wires may be connected by electrical connectors. The method may further including the steps of locating the connected wires in respective ones of the wire-receiving locations of the separator, and enclosing the separator and the connected wires in a splice enclosure. The method may then further include the step of surrounding the connected wires within the enclosure with a sealing material.

In a further aspect, the present invention provides a splice between multi-core cables, in which the connected wires of the spliced cables are located in respective wire-receiving locations of a separator as defined above. The connected wires may be joined together by respective electrical connectors. In a cable splice in accordance with this aspect of the invention, the separator and the connected wires may be contained within a splice enclosure, which may be filled with a sealing material.

### BRIEF DESCRIPTION OF THE DRAWINGS

By way of example only, embodiments of the invention will be described with reference to the accompanying drawings, in which:

FIG. 1 is a perspective view of a splice enclosure.

FIG. 2 shows the splice enclosure in an open condition.

FIGS. 3 and 4 illustrate, diagrammatically, the use of different wire separators in the central section of the splice enclosure of FIGS. 1 and 2.

FIG. 5 is a perspective view of the wire separator of FIG. 3.

FIG. 6 shows the core member of the wire separator of FIG. 5.

FIG. 7 shows a separating arm of the wire separator of FIG. 5.

FIG. 8 illustrates the process of mounting the separating arm of FIG. 7 on the core member of FIG. 6, the core member being shown partly cut away.

FIG. 9 illustrates, diagrammatically, the use of another form of wire separator in the central section of the splice enclosure of FIGS. 1 and 2.

FIG. 10 illustrates the assembly of the wire separator of FIG. 9.

FIG. 11 shows a modified form of the separating arm of FIG. 7.

FIG. 12 a perspective view of an additional embodiment example of a wire separator;

FIG. 13 shows the core element of the wire separator of FIG. 12, and

FIG. 14 shows a separating arm of the wire separator of FIG. 12.

### DETAILED DESCRIPTION

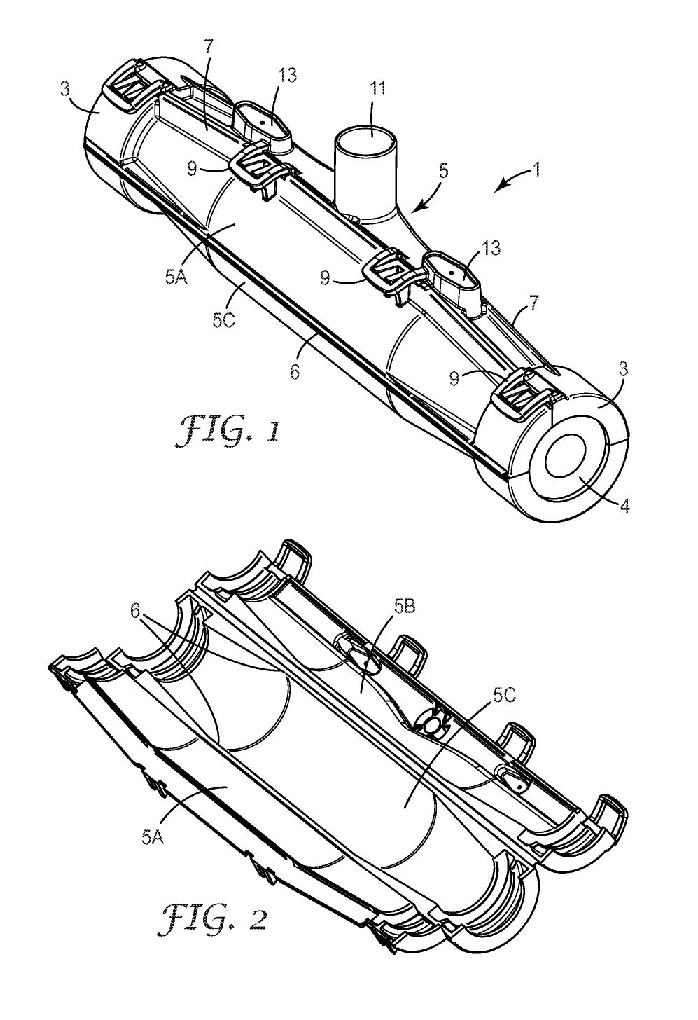

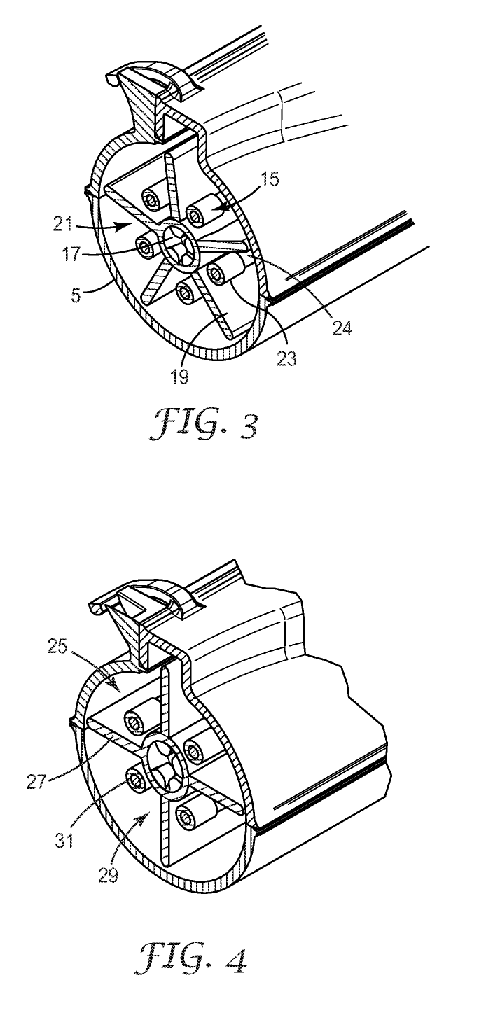

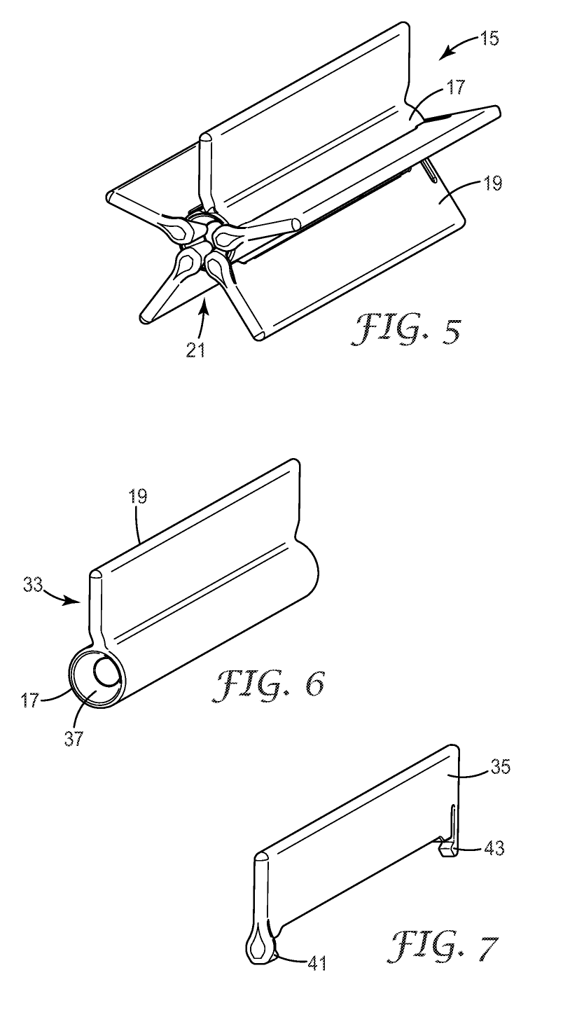

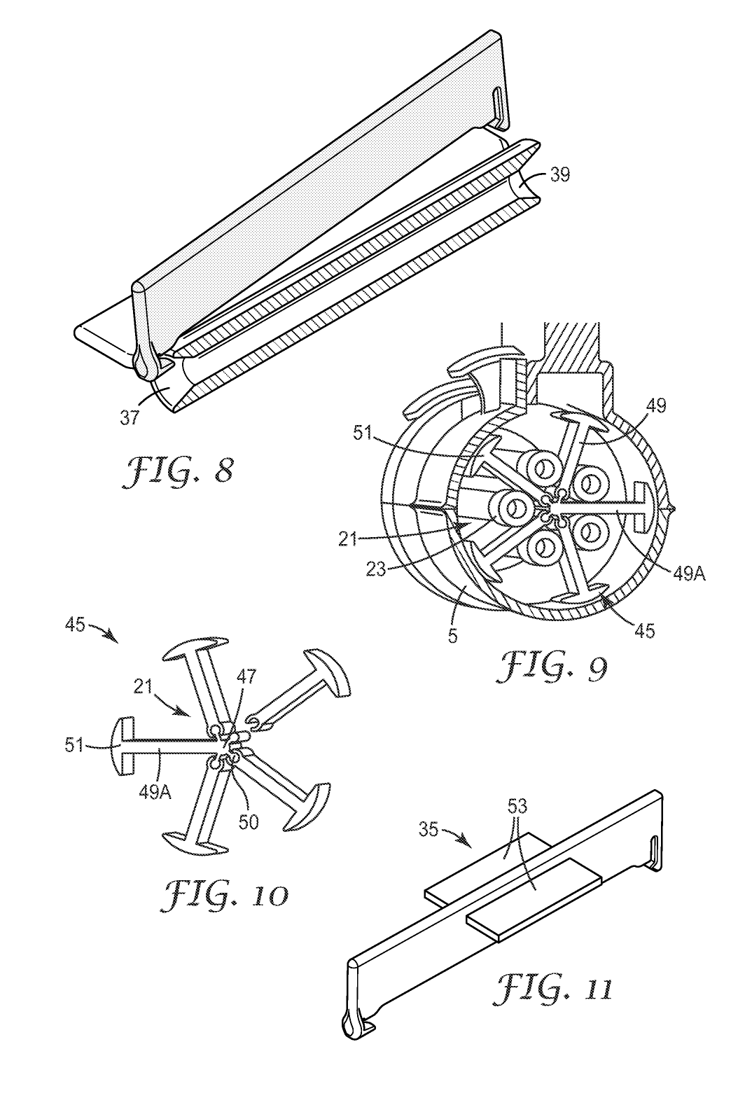

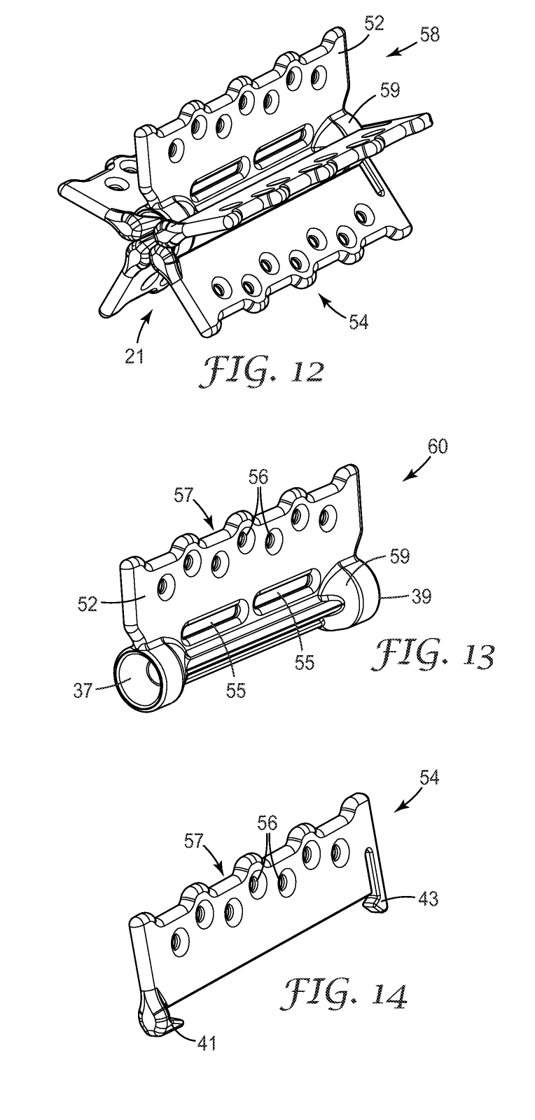

FIG. 1 shows an in-line splice enclosure 1 used to surround, and protect, a splice between two cables (not shown) that enter the enclosure in opposite directions through its end sections 3. Each end section 3 contains a ring of sealing material 4 that surrounds and seals against the sheath of the respective incoming cable.

FIG. 2 shows the enclosure 1 in an open condition, from which it can be closed around a cable splice. The rings of sealing material 4 in the end sections 3 have been omitted from this Figure. The enclosure 1 has a generally-cylindrical central section 5 in which, in use, the cable splice would be positioned, and from which tapered sections 7 extend to the end sections 3. The upper part of the enclosure (as viewed in the drawings) is in two parts 5A, 5B that meet along the top of the enclosure and are hinged to respective edges 6 of the lower part 5C of the enclosure, so that they can be opened out into the position shown in FIG. 2. In-line spliced cables are placed in the open enclosure, with the splice located in the central section 5 and the cables located in the respective end sections 3. The two upper parts 5A, 5B of the enclosure are then closed and latched together at the points 9, bringing the rings of sealing material 4 in the end sections 3 into sealing engagement with the incoming cables, following which a suitable liquid sealing material, for example a suitable resin, is poured into the enclosure 1 through a filler opening 11 in the upper part of the body and allowed to harden. Vents 13 in the upper part of the enclosure 1 allow air to leave the enclosure during the filling procedure.

The formation of an in-line splice between two cables typically involves removal of end portions of the cable sheaths to enable the wires (or, in the case of multi-core cables, the individual wires) of the two cables to be spliced together. In some cases, for example when the wires are to be joined together using suitable wire connectors, the insulation of the end portions of the wires is also removed and, when multi-core cables are involved, it is then essential to maintain a minimum distance between the wires (including, when present, the connectors) in the region where the wire insulation has been removed, and also between the connected wires and the outer surface of the splice enclosure. In the case of low-voltage cables (i.e. cables carrying a voltage no greater than 1000V AC), a typical minimum distance necessary to ensure adequate electrical isolation for the individual wires/connectors is 5 mm. Such minimum distances may be particularly difficult to achieve when the splice enclosure has a comparatively small cross-sectional area, for example 25 mm² or less, but can be ensured through the use of a wire separator in the central section 5 of the enclosure 1 as will be described below.

FIG. 3 shows a first form of wire separator 15 in use in the enclosure 1 of FIGS. 1 and 2, when the enclosure contains a splice between two 5-core cables. The end portions of the cable sheaths and the wire insulation have been removed, and the individual wires of the cables have been spliced together using conventional electrical connectors. Only part of the central section 5 of the enclosure 1 is shown in FIG. 3, the remainder having been omitted for clarity. The separator 15, which is also shown in FIG. 5 removed from the enclosure 1, has a cylindrical core 17 from which five separating arms 19 extend in a radial direction. The separating arms 19 are equi-spaced around the core 17, and the spaces between them define five wire-receiving locations 21 in which the electrical connectors 23 joining together the wires 24 of the 5-core cables are positioned respectively as illustrated in FIG. 3. The arms 19 extend outwards sufficiently far to engage the inner surface of the enclosure 1 and, because they are identical, the core 17 is positioned substantially centrally with respect to the arms and within the enclosure. If desired, cross-pieces (not shown) could be provided at the outer ends of the separating arms 19 to enhance the engagement between the arms and the inner surface of the enclosure.

FIG. 4 shows a similar wire separator 25 intended for use with 4-core cables. The separator 25 differs from the separator 15 of FIG. 3 in that it has only four radially-extending arms 27 and, consequently, provides only four wire-receiving locations 29 in which the electrical connectors 31 joining together the wires (not visible) of the 4-core cables are positioned respectively.

The size of the core 17 in each of the wire separators 15, 25 is selected to ensure that a certain minimum spacing is maintained between the electrical connectors 23, 31 and, hence, between the spliced wires of the two cables.

The assembly of the separator 15 of FIGS. 3 and 5 will now be described with reference to FIGS. 6 to 8. The assembly process will first be described without reference to the spliced cables.

The separator comprises a core member 33 shown in FIG. 6, and four identical arm members 35 each as shown in FIG. 7. The core member 33 provides the core 17 and one of the separating arms 19 of the separator. The ends of the core 17 have conical entry sections 37, 39 both of which are visible in FIG. 8. Each arm member 35 has the form of a plate of similar length to the core 17, with a rigid hook formation 41 at one end and a resiliently-flexible hook formation 43 at the other end. The hook formations 41, 43 are shaped to engage in the conical entry sections 37, 39 of the core and thereby attach the arm member 35 to the core. The attachment process is illustrated in FIG. 8. The rigid hook formation 41 is first fully engaged in the conical entry section 37 of the core, following which the resiliently-flexible hook formation 43 at the other end of the arm member 35 can be snap-fitted over the conical entry section 39 at the other end of the core. Further additional arm members 35 (in this case, three additional arm members) can be attached to the core 17 in the same way to provide the required number of wire-receiving locations 21 around the core.

The separator 25 of FIG. 4 would be assembled in a similar manner.

The tips of the rigid hook formations 41 on the arm members 35 are wedge-shaped to facilitate the process of inserting them into the entry section 37 of the core 17, especially when the available space is limited by the presence of already-installed arm members 35. As an alternative, however, the hook formations at both ends of the arm members 35 could be resiliently-flexible to eliminate the need to distinguish one end of an arm member from the other during assembly of the separator

In practice, the separator 15, 25 is assembled by first positioning the core member 33 between the electrical connectors 23 that join together the wires 24 of the spliced cables. The integral separating arm 19 of the core member 33 extends outwardly between two of the connectors 23 and, by manually squeezing the connectors together, the core 17 can be urged into a central position. The arm members 35 are then attached to the core 17 as described above, each arm member being inserted between a respective pair of the connectors 23. The cable splice, with the assembled separator 15, is then positioned in the centre of the open splice enclosure 1 (FIG. 2) which can then be closed and filled with resin as described above.

The construction of the arm members 35 allows them to move around the core 17 and, thereby, to adopt the optimum position around the core 17 and within the splice enclosure 1. Advantageously, the arm members 35 are slightly flexible to enable them to conform to the space within the splice enclosure 1 and to adjust to the size of the wires 24 of the spliced cables. If required, arm members 35 can be removed from the core 17 by reversing the assembly procedure described above, to provide a wire separator offering fewer wire-receiving locations.

The separator 15, 25 can, if desired, be constructed using a cylindrical core member without an integral separating arm 19, to which the desired number of arm members 35 can be attached. Alternatively, a core member comprising more than one integral wire separating arm could be used.

In a further modification, illustrated in FIG. 11, each arm member 35 of the separator 15, 25 is provided on both sides with outwardly-extending bars 53. Similar bars would be provided on the integral separating arm 19 of the core member of the separator, when present. The bars 53 function as stops to prevent the electrical connectors 23 of the cable splice from moving outwards away from the core 17 of the separator and ensure that the required minimum distance between the connectors 23 and the splice enclosure 1 is maintained.

FIG. 9 shows another form of wire separator 45 in use with 5-core cables in a splice enclosure similar to that of FIGS. 1 and 2. As in FIG. 3, only part of the central section 5 of the splice enclosure is shown in FIG. 9, the remainder having been omitted for clarity. The separator 45 (which is also shown in FIG. 10 removed from the enclosure 1 and partly-assembled) has a solid core 47 from which five separating arms 49 extend in a radial direction. The arms 49 are equi-spaced around the core 47, and the spaces between them define five wire-receiving locations 21 in which, in use, the five spliced wires 23 of the 5-core cables are positioned respectively. The arms 49 extend outwards sufficiently far to engage the inner surface of the splice enclosure 1 and, because they are identical, position the core 47 substantially centrally in the enclosure. Cross pieces 51 having a curved outer surface are provided at the outer ends of the arms 49 to ensure good cooperation with the inner surface of the splice enclosure 1.

One of the arms 49 (indicated by the reference 49A) is formed integrally with the core 47 of the separator 45 but the remaining arms are a snap fit, in the manner of ball-and-socket joints, on attachment formations 50 arranged on the core like the arms of a star. Those arms are able to rotate slightly on the attachment formations 50, enabling them to conform to the space within the splice enclosure and to the size of the wires of the spliced cables. If a smaller number of wire-receiving locations 21 is required, one or more of the separating arms 49 can be omitted, and the positions of the remaining arms will adjust accordingly.

It will be understood that the separator 45 is assembled between the electrical connectors of the spliced cables, in the same way as the separators 15, 25 of FIGS. 3 and 4.

The wire separator 45 of FIGS. 9 and 10 does not extend along the length of the central section 5 of the splice enclosure 1, but could be modified to do so if required. If desired, the cross-pieces 51 at the outer ends of the separating arms 49 could be omitted.

In FIG. 12, an additional embodiment variant of a wire separator 58 is represented. The separator 58 has a cylindrical core 59 from which five separating arms 52 extend in a radial direction. The separating arms 52 are arranged around the core 59 at the same separation from each other, and the areas between them define five wire-receiving locations 21, in which electrical connectors 23, which connect the wires 24 of five-wire cables to each other, can be arranged accordingly. The arms 52 extend so far out that they touch the inner surface of the sleeve 1, and, because they are identical, the core 59 is arranged substantially in the middle with respect to the arms and in the sleeve. The size of the core 59 in the wire separator 58 is chosen in such a way that it is ensured that a certain minimum separation between the electrical connectors 23, 31 and thus between the connected wires of the connected cables is maintained.

The separator presents a core element 60 which is represented in FIG. 13, and four identical arm elements 54, each of which has the appearance represented in FIG. 14. The core element 60 presents a core 59 and one of the separating arms 52 of the separator. The ends of the cores 59 have conical receiving locations 37, 39. Each arm element 54 has the shape of a plate with a length corresponding to the length of the core 59 with a stiff hook formation 41 at one end and an elastic flexible hook formation 43 on the other end. The hook formations 41, 43 are shaped so that they engage in the conical receiving locations 37, 39 of the core, and as a result secure the element 54 on the core. The attachment process corresponds to the attachment process represented in FIG. 8. The tips of the stiff hook formations 41 on the arm elements 54 are designed in wedge shape, to facilitate the process of introduction of the hook into the receiving location 37 of the core 59, particularly when the available space is limited, in case of the presence of already installed arm elements 54. However, alternatively, the hook formations at both ends of the arm elements 54 can be designed to be elastic-flexible to prevent that during the assembly one end of an arm element of the separator 58 must be distinguished from the other.

The construction of the arm elements 54 allows them to move around the core 59, and in the process assume the optimal position around the core 59 and in the connection sleeve 1. Advantageously, the arm elements 54 are slightly flexible to allow them to adapt to the space in the connection sleeve 1 and to the size of the wires 24 of the connected cables. When needed, to make available a wire separator with few wire reception areas, the arm elements 54 can be removed from the core 59 by carrying out the above-described process of the assembly in reverse order.

The wire separator 58 represented in FIGS. 12-14 differs from the wire separator 15 represented in FIGS. 5-7 in that the core 59 presents a cylindrical design only in its marginal areas. In its middle area, the core presents a star-shaped cross section. In addition, the separation arm 52 located on the core presents two longitudinal openings 55 which extend parallel to the core 59. These openings allow the air which is in the sleeve 1 to escape during the filling of the sleeve with resin. In addition, resin can pass through these openings during the filling and spread evenly in the sleeve 1. The separation arm 52 presents, besides the longitudinal openings 55, circular openings 56 along its external margin 57. The circular openings 56 are arranged with mutual offset. The circular openings 56 also serve to allow the air which is in the sleeve to be able to escape during the filling of the sleeve with resin. In addition, the resin can pass through these openings during the filling and spread evenly in the sleeve. The same function is performed by the external margin 57 which has a meandering design in this embodiment example. This shape prevents the external margin 57 from being applied over its entire length against the sleeve wall. Thus, air can escape from or resin can pass through the interstices between the separation arm 52 and the sleeve wall. It is also possible for the wire separator to present only the longitudinal openings 55 or only the circular openings 56 or only the meandering margin 57 or respectively two of these characteristics.

The wire separators 15, 25, 45, 58 described above can be formed from any suitable materials, preferably insulating materials, compatible with the environment in which the separators will be used. A preferred material, selected to ensure good adhesion between the separator and the resin that is poured into the splice enclosure, is polycarbonate (from which the individual components of the separators can be formed by a moulding process). Other materials and manufacturing processes could be used, as appropriate.

The wire separators described above with reference to the drawings are of simple construction but capable of maintaining a specified minimum distance between the connectors and wires of spliced multi-core cables. The minimum distance is defined by the thickness of the separating arms, and will be maintained regardless of the diameters of the electrical connectors that are used to join the wires (assuming that they are within the conventional range). Provided that the electrical connectors are positioned adjacent the centre of the separator, the latter will also serve to define a minimum distance between the connectors/wires and the surrounding splice enclosure. Advantages of the simple construction of the separators are that they are easily manufactured and do not occupy an excessive amount of space within a splice enclosure. They are easily assembled from only two types of components, making them easy to install under field conditions, and are adaptable to accommodate different numbers of cable cores.

It will be appreciated that wire separators as described above with reference to the drawings can be used with other splice configurations, and with various forms of splice enclosures in addition to that shown in FIGS. 1 and 2, if necessary with appropriate modification to take account of the space, within the enclosure, in which the separator will be accommodated. Other forms of splice enclosure are described, for example, in EP 1 122571 (Corning Cable Systems); DE 296 19 002 U (Paul Jordan); DE 199 58 982 (Hoehne GmbH); and DE 42 22 959 (Cellpack AG).

1. A separator for separating the connected wires of spliced multi-core cables in a splice enclosure, the separator comprising a core and a plurality of separating arms extending outwardly from the core to define, around the core, a plurality of locations for receiving the connected wires; wherein some at least of the separating arms are individually-attached to the core whereby the number of said wire-receiving locations can be varied by changing the number of separating arms attached to the core.

2. A separator as claimed in claim 1, in which the core is so shaped that further separating arms can be attached thereto.

3. A separator as claimed in claim 1, in which the core has at least one separating arm permanently-attached thereto.

4. A separator as claimed in claim 1, in which the core is of elongate shape and the separating arms extend lengthwise of the core.

5. A separator as claimed in claim 1, in which the core is centrally-located with respect to the separating arms.

6. A separator as claimed in claim 5, in which the core has a substantially circular cross-section and the separating arms extend generally radially therefrom.

7. A separator as claimed in claim 1, in which the individually-attached separating arms are a snap-fit on the core.

8. A separator as claimed in claim 1, in which the separating arms are movable relative to the core to adjust the size of the wire-receiving locations.

9. A separator as claimed in claim 1, further comprising stops on the separating arms to limit movement of the connected wires away from the core.

10. A cable splice kit comprising a separator as claimed in claim 1 in combination with a splice enclosure; the splice enclosure being shaped to enclose a splice between multi-core cables with the individual spliced wires of the cables located in respective ones of the wire-receiving locations of the wire separator.

11. A kit as claimed in claim 10, in which the outer ends of the separating arms of the wire separator are shaped to support the surrounding splice enclosure.

12. A separator kit for assembling a separator as claimed in claim 1, the kit comprising a core and a plurality of separating arms individually-attachable to the core to extend outwardly from the core member and define, around the core, a required number of the said wire-receiving locations.

13. A method of forming a splice between multi-core cables, the method including the steps of providing a kit as claimed in claim 12, and attaching separating arms to the core to form wire-receiving locations corresponding in number to the number of connected wires in the splice.

14. A splice between multi-core cables, in which the connected wires of the spliced cables are located in respective wire-receiving locations of a separator as claimed in claim 1.

15. A cable splice as claimed in claim 14, in which the separator and the connected wires are contained within a splice enclosure.
